(19) United States
(12) Patent Application Publication
(10) Pub. No.: US 2025/0140912 A1
(43) Pub. Date: May 1, 2025

(54) SULFIDE-BASED SOLID ELECTROLYTE WITH IMPROVED MOISTURE STABILITY AND IONIC CONDUCTIVITY

(71) Applicants: HYUNDAI MOTOR COMPANY, SEOUL (KR); KIA CORPORATION, SEOUL (KR); RESEARCH & BUSINESS FOUNDATION SUNGKYUNKWAN UNIVERSITY, SUWON-SI (KR)

(72) Inventors: Sun Ho Choi, Incheon (KR); Yong Jun Jang, Seongnam-si (KR); Yong Gu Kim, Suwon-si (KR); Sang Heon Lee, Yongin-si (KR); Seong Hyeon Choi, Seongnam-si (KR); Sa Heum Kim, Seoul (KR); Sung Man Cho, Gwacheon-si (KR); Sang Uck Lee, Bucheon-si (KR); Ji Hoon Kim, Ansan-si (KR); Ji Won Lee, Suwon-si (KR); Ji Seon Kim, Suwon-si (KR)

(73) Assignees: HYUNDAI MOTOR COMPANY, SEOUL (KR); KIA CORPORATION, SEOUL (KR); RESEARCH & BUSINESS FOUNDATION SUNGKYUNKWAN UNIVERSITY, SUWON-SI (KR)

(21) Appl. No.: 18/802,779

(22) Filed: Aug. 13, 2024

(30) Foreign Application Priority Data
Oct. 26, 2023 (KR) 10-2023-0144602

(51) Int. Cl. H01M 10/0562; C01B 33/08

(52) U.S. Cl. CPC H01M 10/0562; C01B 33/08; C01P 2002/30; C01P 2002/76; C01P 2006/40; H01M 2300/008

(57) ABSTRACT

A sulfide-based solid electrolyte has an argyrodite-type crystal structure which is doped with an element having an oxidation number of 4 and a transition metal having an oxidation number of 6 so as to improve moisture stability and ionic conductivity of the sulfide-based solid electrolyte.

### CROSS REFERENCE TO RELATED APPLICATIONS

This application claims under 35 U.S.C. § 119(a) the benefit of priority to Korean Patent Application No. 10-2023-0144602 filed on Oct. 26, 2023, the entire contents of which are incorporated herein by reference.

### BACKGROUND

### (a) Technical Field

The present disclosure relates to a sulfide-based solid electrolyte having an argyrodite-type crystal structure. More particularly, it relates to a sulfide-based solid electrolyte having an argyrodite-type crystal structure which is doped with an element having an oxidation number of 4 and a transition metal having an oxidation number of 6 so as to improve moisture stability and ionic conductivity of the sulfide-based solid electrolyte.

### (b) Background Art

Lithium ion batteries are widely used in various apparatuses requiring energy storage. They require various battery characteristics, such as a high energy density, long cycle life, rapid charging and discharging, and high-temperature and low-temperature driving performance, depending on the field of application.

Recently, use of fossil fuels is avoided to solve environmental problems caused by carbon dioxide (CO₂), and there is a great interest in electric vehicles using secondary batteries in the automobile industry. When a currently developed lithium ion battery is used, an electric vehicle may travel about 400 km on a single charge, but problems, such as instability at a high temperature and fires, still exist. In order to solve these problems, many companies are developing next-generation secondary batteries competitively.

All-solid-state batteries, which are attracting attention as a next-generation secondary battery, include all elements formed of solid, and have advantages, such a low risk of fire and explosion and high mechanical strength, as compared to lithium ion batteries using flammable organic solvents as electrolyte solutions.

As a solid electrolyte for all-solid-state batteries, an oxide-based solid electrolyte, a sulfide-based solid electrolyte, or the like may be used, and preferably, a sulfide-based solid electrolyte having high lithium ion conductivity may be used.

However, the sulfide-based solid electrolyte has high moisture reactivity when exposed to the atmosphere and thus generates toxic hydrogen sulfide (H₂S) gas, and therefore, has poor stability in the air. Further, the sulfide-based solid electrolyte has an unstable interface due to contact between a cathode material or an anode material and the sulfide-based solid electrolyte and thus has low-efficiency life characteristics, and may not avoid interfacial resistance between the electrode and the solid electrolyte.

In an effort to solve these problems, various research on not only improvement in ionic conductivity of sulfide-based solid electrolytes but also improvement in moisture reactivity and interfacial stability of all-solid-state batteries is underway.

The above information disclosed in this Background section is only for enhancement of understanding of the background of the disclosure and therefore it may contain information that does not form the prior art that is already known in this country to a person of ordinary skill in the art.

### SUMMARY

The present disclosure has been made in an effort to solve the above-described problems associated with the prior art, and it is an object of the present disclosure to minimize generation of toxic hydrogen sulfide (H₂S) gas through suppression of hydrolysis between a sulfide-based solid electrolyte and moisture (H₂O).

It is another object of the present disclosure to improve interfacial stability between a sulfide-based solid electrolyte and an electrode through improvement in ionic conductivity of the sulfide-based solid electrolyte.

In one aspect, the present disclosure provides a sulfide-based solid electrolyte expressed as Chemical Formula below.

Li_{5+2x+y}AₓSb_{y}B_{1-x-y}S_{5-z}Se_{z}X Chemical Formula 1:

Here, A is an element having an oxidation number of 4, B is a transition metal having an oxidation number of 6, X is at least one selected from Cl, Br, I, and combinations thereof, 0<x<1, 0<y<1, 0<x+y<1, and 0<x<5.

In a preferred embodiment, the element having the oxidation number of 4 may include one selected from the group consisting of silicon (Si), germanium (Ge), tin (Sn), and combinations thereof.

In another preferred embodiment, the transition metal having the oxidation number of 6 may include one selected from the group consisting of tungsten (W), molybdenum (Mo), and a combination thereof.

In still another preferred embodiment, the sulfide-based solid electrolyte may have an argyrodite-type crystal structure.

In yet another preferred embodiment, the element having the oxidation number of 4 and the transition metal having the oxidation number of 6 may be located at 4b sites of the argyrodite-type crystal structure.

In still yet another preferred embodiment, 1-x-y configured to indicate an amount of the transition metal having the oxidation number of 6 may be greater than 0 but less than 0.5.

In a further preferred embodiment, z may be greater than 0 but less than 3.5.

In another further preferred embodiment, the sulfide-based solid electrolyte may belong to a space group F-43m.

In still another further preferred embodiment, selenium (Se) may be substituted for at least some of sulfur (S).

Other aspects and preferred embodiments of the disclosure are discussed infra.

### BRIEF DESCRIPTION OF THE FIGURES

The above and other features of the present disclosure will now be described in detail with reference to certain exemplary embodiments thereof illustrated in the accompanying drawings which are given hereinbelow by way of illustration only, and thus are not limitative of the present disclosure, and wherein:

FIG. 1 is a view illustrating a crystal structure of a sulfide-based solid electrolyte according to the present disclosure;

FIG. 2 is a view illustrating migration paths of lithium ions in a sulfide-based solid electrolyte doped with silicon (Si) using molecular dynamics simulation;

FIG. 3 is a view illustrating migration paths of lithium ions in a sulfide-based solid electrolyte doped with silicon (Si) and tungsten (W) using molecular dynamics simulation; and

FIG. 4 is a view illustrating migration paths of lithium ions in a sulfide-based solid electrolyte doped with silicon (Si) and tungsten (W) and doped with selenium (Se) as substitutes for some of sulfur (S) using molecular dynamics simulation.

It should be understood that the appended drawings are not necessarily to scale, presenting a somewhat simplified representation of various preferred features illustrative of the basic principles of the disclosure. The specific design features of the present disclosure as disclosed herein, including, for example, specific dimensions, orientations, locations, and shapes, will be determined in part by the particular intended application and use environment.

In the figures, reference numbers refer to the same or equivalent parts of the present disclosure throughout the several figures of the drawing.

### DETAILED DESCRIPTION

The above-described objects, other objects, advantages and features of the present disclosure will become apparent from the descriptions of embodiments given hereinbelow with reference to the accompanying drawings. However, the present disclosure is not limited to the embodiments disclosed herein and may be implemented in various different forms. The embodiments are provided to make the description of the present disclosure thorough and to fully convey the scope of the present disclosure to those skilled in the art.

In the drawings, the same or similar elements are denoted by the same reference numerals even though they are depicted in different drawings. In the drawings, the dimensions of structures may be exaggerated compared to the actual dimensions thereof, for clarity of description. In the following description of the embodiments, terms, such as “first” and “second”, may be used to describe various elements but do not limit the elements. These terms are used only to distinguish one element from other elements. For example, a first element may be named a second element, and similarly, a second element may be named a first element, without departing from the scope and spirit of the disclosure. Singular expressions may encompass plural expressions, unless they have clearly different contextual meanings.

In the following description of the embodiments, terms, such as “including,”,“comprising,” and “having,” are to be interpreted as indicating the presence of characteristics, numbers, steps, operations, elements or parts stated in the description or combinations thereof, and do not exclude the presence of one or more other characteristics, numbers, steps, operations, elements, parts or combinations thereof, or possibility of adding the same. In addition, it will be understood that, when a part, such as a layer, a film, a region or a plate, is said to be “on” another part, the part may be located “directly on” the other part or other parts may be interposed between the two parts. In the same manner, it will be understood that, when a part, such as a layer, a film, a region or a plate, is said to be “under” another part, the part may be located “directly under” the other part or other parts may be interposed between the two parts.

All numbers, values and/or expressions representing amounts of components, reaction conditions, polymer compositions and blends used in the description are approximations in which various uncertainties in measurement generated when these values are obtained from essentially different things are reflected and thus it will be understood that they are modified by the term “about”, unless stated otherwise. In addition, it will be understood that, if a numerical range is disclosed in the description, such a range includes all continuous values from a minimum value to a maximum value of the range, unless stated otherwise. Further, if such a range refers to integers, the range includes all integers from a minimum integer to a maximum integer, unless stated otherwise.

In the following description of the embodiments, it will be understood that, when the range of a variable is stated, the variable includes all values within the stated range including stated end points of the range. For example, it will be understood that a range of “5 to 10” includes not only values of 5, 6, 7, 8, 9 and 10 but also arbitrary subranges, such as a subrange of 6 to 10, a subrange of 7 to 10, a subrange of 6 to 9, and a subrange of 7 to 9, and arbitrary values between integers which are valid within the scope of the stated range, such as 5.5, 6.5, 7.5, 5.5 to 8.5, and 6.5 to 9. Further, for example, it will be understood that a range of “10% to 30%” includes not only all integers including values of 10%, 11%, 12%, 13%, . . . 30% but also arbitrary subranges, such as a subrange of 10% to 15%, a subrange of 12% to 18%, and a subrange of 20% to 30%, and arbitrary values between integers which are valid within the scope of the stated range, such as 10.5%, 15.5%, and 25.5%.

A great deal of research on sulfide-based solid electrolytes is underway around the world due to high lithium ion conductivity and electrochemical stability thereof. The sulfide-based solid electrolytes are classified into a crystalline type and a non-crystalline type depending on presence or absence of a crystal structure. There are a thio-LiSiCON-type crystal structure, an LGPS-type crystal structure, and an argyrodite-type crystal structure as representative examples of the crystalline type, and the non-crystalline type may have a glass structure or a glass-ceramic structure depending on a heat treatment temperature.

The argyrodite-type crystal structure is one of a solid electrolyte which has the same crystal structure as argyrodite having composition Ag₈GeS₆ and exhibits lithium ion conductivity. As representative examples of an electrolyte having a Li-argyrodite structure having lithium ion (Li⁺) conductivity used in all-solid-state batteries, Li₇PS₆ and Li₆PS₅X (X being Cl, Br, or I) are known.

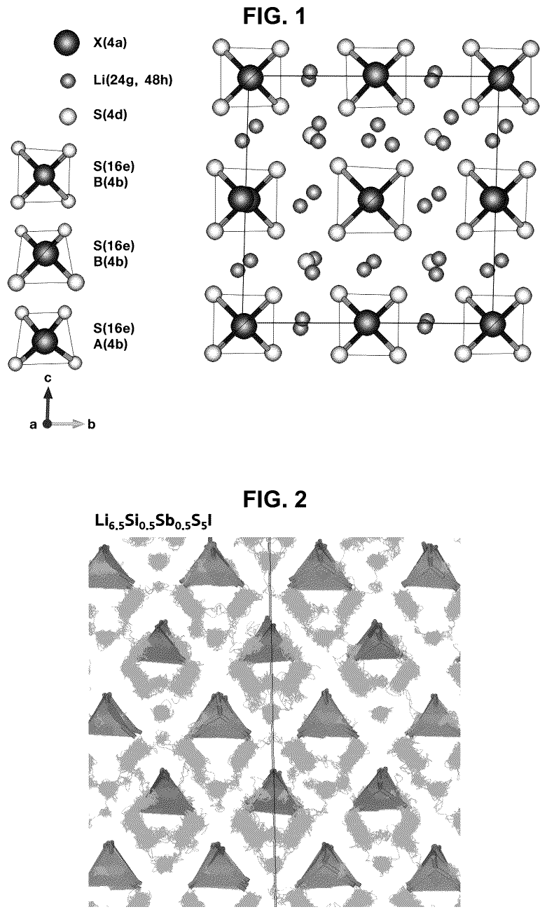

FIG. 1 is a view illustrating a crystal structure of a sulfide-based solid electrolyte according to the present disclosure. The sulfide-based solid electrolyte shown in FIG. 1 may be expressed as Chemical Formula 1 below.

Li_{5+2x+y}AₓSb_{y}B_{1-x-y}S_{5-z}Se_{z}X Chemical Formula 1:

In chemical formula 1, A is an element having an oxidation number of 4, B is a transition metal having an oxidation number of 6, and X is at least one selected from Cl, Br, I, and combinations thereof, 0<x<1, 0<y<1, 0<x+y<1, and 0<x<5.

The sulfide-based solid electrolyte according to the present disclosure may have an argyrodite-type crystal structure. Referring to FIG. 1, in the argyrodite-type crystal structure, sulfur (S) may form tetrahedrons AS₄³⁻, BS₄³⁻ and SbS₄³⁻ centering around elements A and B and antimony (Sb), respectively. Here, the centers of the tetrahedrons may be located at 4b sites.

The conventional sulfide-based solid electrolyte Li₆PS₅X (X being Cl, Br, or I) having the argyrodite-type crystal structure includes tetrahedrons PS₄³⁻ in the crystal structure, and phosphorus (P) may be located at the centers of the tetrahedrons. Referring to this, in the present disclosure, the sites of phosphorus (P) of the conventional sulfide-based solid electrolyte Li₆PS₅X having the argyrodite-type crystal structure may be substitutionally doped with the elements A and B and antimony (Sb).

Here, the sulfide-based solid electrolyte according to the present disclosure may be configured such that the elements A and B and antimony (Sb) may be substituted for all phosphorus (P) of the conventional sulfide-based solid electrolyte having the composition Li₆PS₅X. Therefore, the sulfide-based solid electrolyte according to the present disclosure may not include phosphorus (P).

Further, referring to FIG. 1, the elements A and B and antimony (Sb) may be expressed as being located at the 4b sites of the argyrodite-type crystal structure.

According to the present disclosure, as the transition metal B having the oxidation number of 6 and a large ionic radius is substituted for the sites of phosphorus (P), a crystal lattice volume may be increased. As the crystal lattice volume is increased, activation energy with respect to migration of lithium ions in the crystal lattice may be reduced, and thereby, lithium ion conductivity may be increased.

Further, the transition metal B substituted for the sites of phosphorus (P) may induce occurrence of vacancies in the crystal lattice. Occurrence of vacancies may facilitate formation of a cubic phase, and the cubic phase has sufficient migration paths of lithium ions (Li⁺) and may thus facilitate 3D fast conduction. Thereby, improvement in lithium ion conductivity of the sulfide-based solid electrolyte may be promoted.

Here, 1-x-y indicating the amount of the transition metal B in the sulfide-based solid electrolyte may be greater than 0 but less than 1. Preferably, 1-x-y may be greater than 0 but less than 0.5. When 1-x-y indicating the amount of the transition metal B in the sulfide-based solid electrolyte is less than 0.5, lithium ion conductivity of the sulfide-based solid electrolyte may be further improved.

Further, the transition metal B reacts with sulfur (S) and thus forms BS₂ during a process of generating H₂S gas through reaction between moisture (H₂O) present in the air and the sulfide-based solid electrolyte, thereby being capable of suppressing generation of toxic hydrogen sulfide gas.

In one embodiment, the element A having the oxidation number of 4 may include a group 4 element on the periodic table. Preferably, the element A may include at least one selected from the group consisting of silicon (Si), germanium (Ge), tin (Sn), and combinations thereof. Further, the transition metal B having the oxidation number of 6 may include at least one selected from the group consisting of tungsten (W), molybdenum (Mo), and a combination thereof.

z indicating the amount of selenium (Se) in the sulfide-based solid electrolyte may be greater than 0 but less than 5. Preferably, z may be greater than 0 but less than 3.5. When z indicating the amount of selenium (Se) in the sulfide-based solid electrolyte is less than 3.5, generation of H₂S gas caused by hydrolysis may be further suppressed. Here, selenium (Se) may be substituted for at least some of sulfur (S).

Further, the sulfide-based solid electrolyte according to the present disclosure may belong to, for example, a cubic crystal system, and more concretely, may belong to the space group F-43m.

Hereinafter, the present disclosure will be described in more detail through the following Examples and Comparative Examples. The following Examples and Comparative Examples serve merely to exemplarily describe the present disclosure, and are not intended to limit the scope and spirit of the disclosure.

### Test Example 1: Detection of Migration Paths of Lithium Ions (Lit)

Migration paths of lithium ions (Li⁺) in sulfide-based solid electrolytes having the argyrodite-type crystal structure were predicted using molecular dynamics simulation.

Concretely, molecular dynamics simulation of a sulfide-based solid electrolyte having composition Li_{6.5}Si_{0.5}Sb_{0.5}S₅I, which does not include a transition metal having an oxidation number of 6 and selenium (Se), was executed, and simulation results are shown in FIG. 2. Here, green areas indicate tetrahedrons including Si and Sb, and purple lines indicate migration paths of lithium ions (Li⁺).

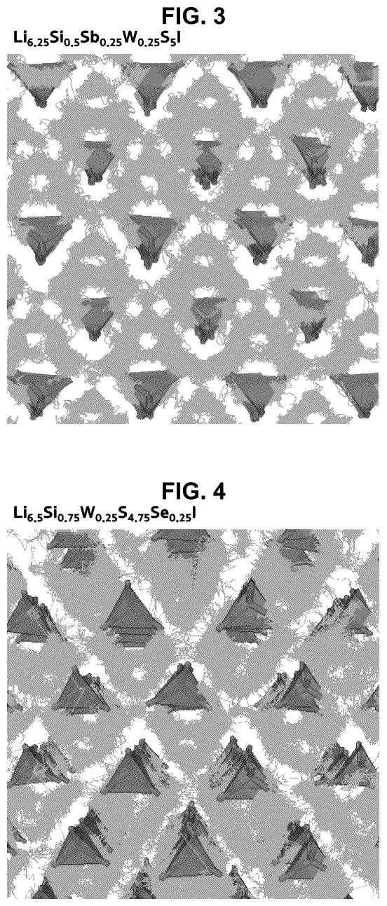

Further, molecular dynamics simulation of a sulfide-based solid electrolyte having composition Li_{6.25}Si_{0.5}Sb_{0.25}W_{0.25}S₅I, which does not include selenium (Se), was executed, and simulation results are shown in FIG. 3. Here, blue areas indicate tetrahedrons including Si, Sb, W and S, and purple lines indicate migration paths of lithium ions (Li⁺).

Moreover, molecular dynamics simulation of a sulfide-based solid electrolyte having composition Li_{6.5}Si_{0.75}W0_{.25}S_{4.75}Se_{0.25}I, which includes a transition metal having an oxidation number of 6 and selenium (Se) but does not include antimony (Sb), was executed, and simulation results are shown in FIG. 4. Here, blue areas indicate tetrahedrons including Si, W, Se and S, and purple lines indicate migration paths of lithium ions (Li⁺).

Referring to FIGS. 2 to 4, it may be confirmed that, in the sulfide-based solid electrolyte including W, which is a transition metal having an oxidation number of 6, lithium ions (Li⁺) more actively migrate around the tetrahedrons. Thereby, it may be predicted that the sulfide-based solid electrolyte including W has higher lithium ion conductivity.

### Test Example 2: Lithium Ion Conductivities and Synthesis Possibilities of Sulfide-Based Solid Electrolytes Having Various Compositions

Lithium ion conductivities of sulfide-based solid electrolytes having various compositions, activation energies (Eₐ) required for migration of lithium ions, and energies above hull (Eₕᵤₗₗ) of the sulfide-based solid electrolytes were calculated using a molecular dynamics calculation method through machine learning, and are set forth in Table 1 below.

The energy above hull (Eₕᵤₗₗ) is an index to evaluate synthesis possibility of a material, it is determined that synthesis possibility of the material is higher as the energy above hull (Eₕᵤₗₗ) is closer to 0, and it is generally evaluated that it is possible to synthesize the material when the energy above hull (Eₕᵤₗₗ) is 100 or less.

80% ionic conductivity (80% IC) was calculated by Equation below.

σ_{exp.}=σ_{calc.}X_{c}^{7.14} Equation:

Here, X_{c} indicates a degree of crystallinity, and 0.8 is substituted thereinto in the case of a 80% crystal structure. σ_{calc.} indicates a calculated lithium ion conductivity, i.e., a bulk ionic conductivity (BIC).

TABLE 1

| | | | BIC | 80% IC | |
|---|---|---|---|---|---|
| Category | Chemical formula | Eₐ (eV) | (mS/cm) | (mS/cm) | Eₕᵤₗₗ |
| P | Li₆PS₅I | 0.32 | 4.17 | 0.85 | 15 |
| P—W | Li_{5.75}P_{0.75}W_{0.25}SsI | 0.43 | 0.01 | 2.03 × 10⁻³ | 19 |
| | Li₅.₅P_{0.5}W_{0.5}S₅I | 0.36 | 0.06 | 0.01 | 31 |
| | Li_{5.25}P_{0.25}W_{0.75}S₅I | 0.42 | 0.02 | 4.07 × 10⁻³ | 42 |
| P—Mo | Li_{5.75}P_{0.75}Mo_{0.25}SsI | 0.45 | 0.004 | 8.13 × 10⁻⁴ | 25 |
| | Li₅.₅P_{0.5}Mo_{0.5}S₅I | 0.46 | 0.005 | 1.02 × 10⁻³ | 48 |
| | Li_{5.25}P_{0.25}Mo_{0.75}S₅I | 0.47 | 0.004 | 8.13 × 10⁻⁴ | 67 |
| Si—Sb | Li_{6.25}Si_{0.25}Sb_{0.75}S₅I | 0.20 | 10.4 | 2.11 | 25 |
| | Li_{6.5}Si_{0.5}Sb_{0.5}S₅I | 0.20 | 13.6 | 2.76 | — |
| | Li_{6.75}Si_{0.75}Sb_{0.25}S₅I | 0.21 | 14.8 | 3.01 | 0 |
| Sb | Li₆SbS₅I | 0.71 | 0.00004 | 8.13 × 10⁻⁶ | 34 |
| Si | Li₇SiS₅I | 0.19 | 47.85 | 9.73 | — |
| SiS₄—S | Li_{6.5}Si_{0.75}W_{0.25}Se_{0.25}S_{4.75}I | 0.15 | 11.73 | — | — |
| Single S | Li_{6.5}Si_{0.75}W_{0.25}Se_{0.25}S_{4.75}I | 0.15 | 5.02 | 4 | — |
| Si—Sb—W | Li_{6.25}Si_{0.5}Sb_{0.25}W_{0.25}S₅I | 0.16 | 33.74 | 6.86 | 5 |
| | Li₆Si_{0.25}Sb_{0.5}W_{0.25}S₅I | 0.32 | 0.16 | 0.03 | 19 |
| | Li_{5.75}Si_{0.25}Sb_{0.25}W_{0.5}S₅I | 0.21 | 0.40 | 0.08 | 35 |
| Sb—W | Li_{5.75}Sb_{0.75}W_{0.25}S₅I | 0.28 | 0.19 | 0.04 | 37 |
| | Li₅.₅Sb_{0.5}W_{0.5}S₅I | 0.37 | 0.11 | 0.02 | 48 |
| | Li_{5.25}Sb_{0.25}W_{0.75}S₅I | 0.35 | 0.14 | 0.03 | 62 |
| Si—W | Li_{6.5}Si_{0.75}W_{0.25}S₅I | 0.14 | 62.93 | 12.79 | — |
| | Li₆Si_{0.5}W_{0.5}S₅I | 0.34 | 0.30 | 0.06 | 9 |
| | Li₅.₅Si_{0.25}W_{0.75}S₅I | 0.21 | 0.40 | 0.08 | 33 |
| Si—Sb—Mo | Li_{6.25}Si_{0.5}Sb_{0.25}Mo_{0.25}S₅I | 0.15 | 33.05 | 6.72 | 10 |
| | Li₆Si_{0.25}Sb_{0.5}Mo_{0.25}S₅I | 0.33 | 0.06 | 0.01 | 47 |
| | Li_{5.75}Si_{0.25}Sb_{0.25}Mo_{0.5}S₅I | 027 | 0.30 | 0.06 | 24 |
| Sb—Mo | Li_{5.75}Sb_{0.75}Mo_{0.25}S₅I | 0.25 | 0.23 | 0.05 | 46 |
| | Li₅.₅Sb_{0.5}Mo_{0.5}S₅I | 0.20 | 0.46 | 0.09 | 65 |
| | Li_{5.25}Sb_{0.25}Mo_{0.75}S₅I | 0.43 | 0.016 | 3.25 × 10⁻³ | 87 |
| Si—Mo | Li_{6.5}Si_{0.75}Mo_{0.25}S₅I | 0.15 | 52.14 | 10.60 | 3 |
| | Li₆Si_{0.5}Mo_{0.5}S₅I | 0.28 | 1.03 | 0.21 | 21 |
| | Li₅.₅Si_{0.25}Mo_{0.75}S₅I | 0.24 | 1.25 | 0.25 | 57 |
| Ge—Sb—W | Li_{6.25}Ge_{0.5}Sb_{0.25}W_{0.25}S₅I | 0.17 | 17.78 | 3.61 | 30 |
| | Li₆Ge_{0.25}Sb_{0.5}W_{0.25}S₅I | 0.36 | 0.06 | 0.01 | 31 |
| | Li_{5.75}Ge_{0.25}Sb_{0.25}W_{0.5}S₅I | 0.20 | 1.27 | 0.26 | 44 |
| Ge—W | Li_{6.5}Ge_{0.75}W_{0.25}S₅I | 0.15 | 51.98 | 10.57 | 35 |
| | Li₆Ge_{0.5}W_{0.5}S₅I | 0.22 | 2.22 | 0.45 | 33 |
| Ge—Mo | Li_{6.5}Ge_{0.75}Mo_{0.25}S₅I | 0.16 | 27.14 | 5.52 | 43 |
| | Li₆Ge_{0.5}Mo_{0.5}S₅I | 0.18 | 5.5 | 1.12 | 49 |
| Ge—Sb—Mo | Li_{6.25}Ge_{0.5}Sb_{0.25}Mo_{0.25}S₅I | 0.17 | 16.35 | 3.32 | 37 |
| | Li₆Ge_{0.25}Sb_{0.5}Mo_{0.25}S₅I | 0.29 | 0.21 | 0.043 | 39 |
| | Li_{5.75}Ge_{0.25}Sb_{0.25}Mo_{0.5}S₅I | 0.15 | 0.86 | 0.17 | 60 |

In general, it may be determined that, when 80% ionic conductivity of a solid electrolyte is 1 mS/cm or more, there is a possibility of commercialization of the solid electrolyte. Referring to Table 1, the bulk ionic conductivities of sulfide-based solid electrolytes having phosphorus (P) were calculated to be low.

### Test Example 3: Hydrolysis Reactions and Hydrogen Sulfide Gas Generation Energies of Sulfide-Based Solid Electrolytes Having Various Compositions

In order to evaluate moisture stabilities of sulfide-based solid electrolytes according to the present disclosure, hydrogen sulfide gas generation energies of the sulfide-based solid electrolytes were calculated using Density Functional Theory (DFT). A calculation process is as follows.
1). A pseudo-binary reaction formula to the composition C of products formed as the result of a reaction between a solid electrolyte SE to be calculated and H₂O was designed.

C_{products}(SE,H₂O,x)=x·C(SE)+(1−x)C(H₂O) Reaction Formula 1:
2). Reaction energy for such a formula was calculated as below.

E_{reaction}(SE,H₂O,x)=E_{eq}(C_{products}(SE,H₂O,x))−E(C_{products}(SE,H₂O,x)) Reaction Formula 2:

Here, eq indicates a phase equilibria state among the products acquired from the reaction formula (1).
3). Reaction energies E_{reaction} of x were calculated by substituting values of x in the range of 0<x<1 into the above formula, and reaction with the value of x having the lowest reaction energy was determined as a reaction formula between the solid electrolyte SE to be calculated and H₂O.
4). The reaction formula was normalized with respect to H₂S so as to compare the reaction energies of various solid electrolytes SE.
5). Hydrogen sulfide gas generation energy E_{g} was finally acquired by dividing the reaction energy by a conversion factor, acquired in consideration of a conversion rate indicating participation of sulfur (S) included in the solid electrolyte SE, which is a reactant, in hydrogen sulfide gas generation.

The hydrogen sulfide gas generation energies E_{g} of the solid electrolytes SE and the reaction formulas used to calculate the hydrogen sulfide gas generation energies E_{g} are set forth in Table 2 below.

TABLE 2

| | | | Eg |
|---|---|---|---|
| Category | Chemical formula | Reaction formula | (eV) |
| Orig | Li₆PS₅Cl | 0.33Li₆PS₅Cl + 1.33H₂O → H₂S + 0.67LiHS + | −0.44 |
| | | 0.33LiCl + 0.33Li₃PO₄ | |
| | Li₆PS₅I | 1.33 H₂O + 0.33 Li₆PS₅I → H₂S + 0.67 LiHS + | −0.23 |
| | | 0.33 LiI + 0.33 Li₃PO₄ | |
| Si—I | Li₇SiS₅I | H₂O + 0.33 Li₇SiS₅I → H₂S + 0.67 Li₂S + 0.33 | −0.21 |
| | | LiI + 0.33 Li₂SiO₃ | |
| Sb—I | Li₆SbS₅I | H₂O + Li₆SbS₅I → 0.5 Li₃SbS₃ + 0.25 Li₂SO₄ + | 0.08 |
| | | H₂S + 0.75 Li₂S + 0.5 Li₅SbS₃I₂ | |
| Si—Sb—I | Li_{6.25}Si_{0.25}Sb_{0.75}S₅I | 0.14 Li₂₅SiSb₃S₂0I₄ + H₂O → 0.14 Li₃SbS₃ + | 0.03 |
| | | 0.11 Li₂SO₄ + H₂S + 0.46Li₂S + 0.14 Li₄SiO₄ + | |
| | | 0.29 Li₅SbS₃I₂ | |
| | Li_{6.5}Si_{0.5}Sb_{0.5}S₅I | 0.5 Li_{6.5}Si_{0.5}Sb_{0.5}S₅I + H₂O → 0.25 Li₅SbS₃I₂ + | −0.07 |
| | | H₂S + 0.69 Li₂S + 0.25 Li₂SiO₃ + 0.06Li₂SO₄ | |
| | Li_{6.75}Si_{0.75}Sb_{0.25}S₅I | 0.11 Li₂₇Si₃SbS₂₀I₄ + H₂O → 0.11 Li₃SbS₄ + | −0.16 |
| | | H₂S + 0.78 Li₂S + 0.44 LiI + 0.33 Li₂SiO₃ | |
| Si—Sb—W—I | Li_{6.25}Si_{0.5}Sb_{0.25}W_{0.25}S₅I | H₂O + 0.13 Li₂₅Si₂SbWS₂₀I₄ → 0.063 Li₂SO₄ + | −0.07 |
| | | H₂S + 0.81 Li₂S + 0.25 LiI + 0.25 Li₂SiO₃ + | |
| | | 0.13 WS₂ + 0.13 Li₅SbS₃I₂ | |
| | Li₆Si_{0.25}Sb_{0.5}W_{0.25}S₅I | H₂O + 0.14 Li₂₄SiSb₂WS₂₀I₄ → 0.11 Li₂SO₄ + | 0.02 |
| | | H₂S + 0.61 Li₂S + 0.14 Li₄SiO₄ + 0.14 WS₂ + | |
| | | 0.29 Li₅SbS₃I₂ | |
| | Li_{5.75}Si_{0.25}Sb_{0.25}W_{0.5}S₅I | H₂O + 0.14 Li₂₃SiSbW₂S₂₀I₄ → 0.11 Li₂SO₄ + | 0.02 |
| | | H₂S + 0.75 Li₂S + 0.29 LiI + 0.14 Li₄SiO₄ + 0.29 | |
| | | WS₂ + 0.14 Li₅SbS₃I₂ | |
| Sb—W—I | Li_{5.75}Sb_{0.75}W_{0.25}S₅I | 0.096Li₂₃Sb₃W₂S₂₀I₄ + H₂O → H₂S + 0.539 Li₂S + | 0.36 |
| | | 0.038 Sb + 0.39 LiI + 0.192 WS₂ + 0.25 Li₃SbO₄ | |
| | Li_{5.5}Sb_{0.5}W_{0.5}S₅I | Li_{5.5}Sb_{0.5}W_{0.5}S₅I + H₂O → 0.5 Li₅SbS₃I₂ + H₂S + | 0.07 |
| | | 1.25 Li₂S + 0.5 WS₂ + 0.25 Li₂SO₄ | |
| | Li_{5.25}Sb_{0.25}W_{0.75}S₅I | 0.25 Li₂₁SbW₃S₂₀I₄ + H₂O → 0.25 Li₅SbS₃I₂ + | 0.06 |
| | | H₂S + 1.5 Li₂S + 0.5 LiI + 0.75 WS₂ + 0.25 Li₂SO₄ | |
| Si—W—I | Li_{6.5}Si_{0.75}W_{0.25}S₅I | 0.1 Li₂₆Si₃WS₂₀I₄ + H₂O → H₂S + 0.78 Li₂S + | −0.15 |
| | | 0.4 LiI + 0.3 Li₂SiO₃ + 0.1 WS₂ + 0.025 Li₂SO₄ | |
| | Li₆Si_{0.5}W_{0.5}S₅I | 0.5 Li₆Si_{0.5}W_{0.5}S₅I + H₂O → H₂S + 0.94 Li₂S + | −0.10 |
| | | 0.5 LiI + 0.25 Li₂SiO₃ + 0.25 WS₂ + 0.06Li₂SO₄ | |
| | Li_{5.5}Si_{0.25}W_{0.75}S₅I | 0.14 Li₂₂SiW₃S₂₀I₄ + H₂O → H₂S + 0.90 Li₂S + | −0.15 |
| | | 0.57 LiI + 0.14 Li₄SiO₄ + 0.43 WS₂ + 0.11 Li₂SO₄ | |
| Si—Sb—W—Br | Li_{6.25}Si_{0.5}Sb_{0.25}W_{0.25}S₅Br | 0.143 Li₂₅Si₂SbWS₂₀Br₄ + H₂O → 0.143 Li₃SbS₄ + | −0.10 |
| | | 0.571 LiBr + H₂S + 0.964 Li₂S + 0.286Li₂SiO₃ + | |
| | | 0.143 WS₂ + 0.04 Li₂SO₄ | |
| | Li₆Si_{0.25}Sb_{0.5}W_{0.25}S₅Br | 0.143 Li₂₄SiSb₂WS₂₀Br₄ + H₂O → 0.286Li₃SbS₃ + | 0.02 |
| | | 0.571 LiBr + H₂S + 0.607 Li₂S + 0.143 Li₄SiO₄ + | |
| | | 0.143 WS₂ + 0.107 Li₂SO₄ | |
| | Li_{5.75}Si_{0.25}Sb_{0.25}W_{0.5}S₅Br | 0.143 Li₂₃SiSbW₂S₂₀Br₄ + H₂O → 0.143 Li₃SbS₃ + | 0.004 |
| | | 0.571 LiBr + H₂S + 0.75 Li₂S + 0.143 Li₄SiO₄ + | |
| | | 0.286WS₂ + 0.107 Li₂SO₄ | |
| Sb—W—Br | Li_{5.75}Sb_{0.75}W_{0.25}S₅Br | H₂O + 0.25 Li₂₃Sb₃WS₂₀Br₄ → 0.75 Li₃SbS₃ + | 0.07 |
| | | LiBr + H₂S + Li₂S + 0.25 WS₂ + 0.25 Li₂SO₄ | |
| | Li_{5.5}Sb_{0.5}W_{0.5}S₅Br | H₂O + Li_{5.5}Sb_{0.5}W_{0.5}S₅Br → 0.5 Li₃SbS₃ + LiBr + | 0.06 |
| | | H₂S + 1.25 Li₂S + 0.5 WS₂ + 0.25 Li₂SO₄ | |
| | Li_{5.25}Sb_{0.25}W_{0.75}S₅Br | H₂O + 0.25 Li₂₁SbW₃S₂₀Br₄ → 0.25 Li₃SbS₃ + | 0.04 |
| | | LiBr + H₂S + 1.5 Li₂S + 0.75 WS₂ + 0.25 Li₂SO₄ | |
| Si—W—Br | Li_{6.5}Si_{0.75}W_{0.25}S₅Br | H₂O + 0.1 Li₂₆Si₃WS₂₀Br₄ → 0.4 LiBr + H₂S + | −0.15 |
| | | 0.78 Li₂S + 0.3 Li₂SiO₃ + 0.1 WS₂ + 0.03 Li₂SO₄ | |
| | Li₆Si_{0.5}W_{0.5}S₅Br | H₂O + 0.5 Li₆Si_{0.5}W_{0.5}S₅Br → 0.5 LiBr + H₂S + | −0.10 |
| | | 0.94 Li₂S + 0.25 Li₂SiO₃ + 0.25 WS₂ + 0.06Li₂SO₄ | |
| | Li_{5.5}Si_{0.25}W_{0.75}S₅Br | H₂O + 0.143 Li₂₂SiW₃S₂₀Br₄ → 0.571 LiBr + | −0.01 |
| | | H₂S + 0.893 Li₂S + 0.143 Li₄SiO₄ + 0.429 WS₂ + | |
| | | 0.107 Li₂SO₄ | |
| Si—Sb—W—Cl | Li_{6.25}Si_{0.5}Sb_{0.25}W_{0.25}S₅Cl | H₂O + 0.14 Li₂₅Si₂SbWS₂₀Cl₄ → 0.14 Li₃SbS₄ + | −0.10 |
| | | H₂S + 0.96Li₂S + 0.571 LiCl + 0.29 Li₂SiO₃ + 0.14 | |
| | | WS₂ + 0.036Li₂SO₄ | |
| | Li₆Si_{0.25}Sb_{0.5}W_{0.25}S₅Cl | H₂O + 0.14 Li₂₄SiSb₂WS₂₀Cl₄ → 0.29 Li₃SbS₃ + | 0.02 |
| | | H₂S + 0.61 Li₂S + 0.57 LiCl + 0.14 Li₄SiO₄ + | |
| | | 0.14 WS₂ + 0.11 Li₂SO₄ | |
| | Li_{5.75}Si_{0.25}Sb_{0.25}W_{0.5}S₅Cl | H₂O + 0.14 Li₂₃SiSbW₂S₂₀Cl₄ → 0.143 Li₃SbS₃ + | 0.004 |
| | | H₂S + 0.75 Li₂S + 0.571 LiCl + 0.143 Li₄SiO₄ + | |
| | | 0.286WS₂ + 0.107 Li₂SO₄ | |
| Sb—W—Cl | Li_{5.75}Sb_{0.75}W_{0.25}S₅Cl | 0.25 Li₂₃Sb₃WS₂₀Cl₄ + H₂O → 0.75 Li₃SbS₃ + | 0.07 |
| | | H₂S + Li₂S + LiCl + 0.25 WS₂ + 0.25 Li₂SO₄ | |
| | Li_{5.5}Sb_{0.5}W_{0.5}S₅Cl | Li_{5.5}Sb_{0.5}W_{0.5}S₅Cl + H₂O → 0.5 Li₃SbS₃ + H₂S + | 0.06 |
| | | 1.25 Li₂S + LiCl + 0.5 WS₂ + 0.25 Li₂SO₄ | |
| | Li_{5.25}Sb_{0.25}W_{0.75}S₅Cl | 0.25 Li₂₁SbW₃S₂₀Cl₄ + H₂O → 0.25 Li₃SbS₃ + | 0.04 |
| | | H₂S + 1.5 Li₂S + LiCl + 0.75 WS₂ + 0.25 Li₂SO₄ | |
| Si—W—Cl | Li_{6.5}Si_{0.75}W_{0.25}S₅Cl | H₂O + 0.1 Li₂₆Si₃WS₂₀Cl₄ → H₂S + 0.78 Li₂S + | −0.15 |
| | | 0.4 LiCl + 0.3 Li₂SiO₃ + 0.1 WS₂ + 0.03 Li₂SO₄ | |
| | Li₆Si_{0.5}W_{0.5}S₅Cl | H₂O + 0.5 Li₆Si_{0.5}W_{0.5}S₅Cl → H₂S + 0.94 Li₂S + | −0.10 |
| | | 0.5 LiCl + 0.25 Li₂SiO₃ + 0.25 WS₂ + 0.06Li₂SO₄ | |
| | Li_{5.5}Si_{0.25}W_{0.75}S₅Cl | H₂O + 0.14 Li₂₂SiW₃S₂₀Cl₄ → H₂S + 0.89 Li₂S + | −0.01 |
| | | 0.57 LiCl + 0.14 Li₄SiO₄ + 0.43 WS₂ + 0.11 Li₂SO₄ | |
| Si—Sb—Mo—I | Li_{6.25}Si_{0.5}Sb_{0.25}Mo_{0.25}S₅I | H₂O + 0.13 Li₂₅Si₂SbMoS₂₀I₄ → 0.063 Li₂SO₄ + | −0.07 |
| | | H₂S + 0.81 Li₂S + 0.25 LiI + 0.25 Li₂SiO₃ + 0.13 | |
| | | MoS₂ + 0.13 Li₅SbS₃I₂ | |
| | Li₆Si_{0.25}Sb_{0.5}Mo_{0.25}S₅I | H₂O + 0.14 Li₂₄SiSb₂MoS₂₀I₄ → 0.11 Li₂SO₄ + | 0.21 |
| | | H₂S + 0.61 Li₂S + 0.14 Li₄SiO₄ + 0.14 MoS₂ + | |
| | | 0.29 Li₅SbS₃I₂ | |
| | Li_{5.75}Si_{0.25}Sb_{0.25}Mo_{0.5}S₅I | H₂O + 0.14 Li₂₃SiSbMo₂S₂₀I₄ → 0.11 Li₂SO₄ + | 0.02 |
| | | H₂S + 0.75 Li₂S + 0.29 LiI + 0.14 Li₄SiO₄ + 0.29 | |
| | | MoS₂ + 0.14 Li₅SbS₃I₂ | |
| Sb—Mo—I | Li_{5.75}Sb_{0.75}Mo_{0.25}S₅I | 0.077 Li₂₃Sb₃MoS₂₀I₄ + H₂O → H₂S + 0.37 Li₂S + | 0.42 |
| | | 0.31 LiI + 0.077 MoS₂ + 0.019 Li₂SO₄ + 0.23 | |
| | | Li₃SbO₄ | |
| | Li_{5.5}Sb_{0.5}Mo_{0.5}S₅I | 0.4 Li_{5.5}Sb_{0.5}Mo_{0.5}S₅Cl + H₂O → H₂S + 0.55 | 0.28 |
| | | Li₂S + 0.4 LiCl + 0.2 MoS₂ + 0.05 Li₂SO₄ + 0.2 | |
| | | Li₃SbO₄ | |
| | Li_{5.25}Sb_{0.25}Mo_{0.75}S₅I | 0.14 Li₂1SbMo₃S₂₀I₄ + H₂O → H₂S + 0.89 Li₂S + | 0.18 |
| | | 0.571 LiI + 0.43 MoS₂ + 0.11 Li₂SO₄ + 0.14 | |
| | | Li₃SbO₄ | |
| Si—Mo—I | Li_{6.5}Si_{0.75}Mo_{0.25}S₅I | 0.1 Li₂₆Si₃MoS₂₀I₄ + H₂O → H₂S + 0.775 Li₂S + | −0.15 |
| | | 0.4 LiI + 0.3 Li₂SiO₃ + 0.1 MoS₂ + 0.025 Li₂SO₄ | |
| | Li₆Si_{0.5}Mo_{0.5}S₅I | H₂O + 0.4 Li₆Si_{0.5}Mo_{0.5}S₅Cl → H₂S + 0.55 Li₂S + | −0.05 |
| | | 0.4 LiCl + 0.2 Li₄SiO₄ + 0.2 MoS₂ + 0.05 | |
| | | Li₂SO₄ | |
| | Li_{5.5}Si_{0.25}Mo_{0.75}S₅I | 0.143 Li₂₂SiMo₃S₂₀I₄ + H₂O → H₂S + 0.893 | −0.01 |
| | | Li₂S + 0.571 LiI + 0.143 Li₄SiO₄ + 0.429 MoS₂ + | |
| | | 0.107 Li₂SO₄ | |
| Si—Sb—Mo—Br | Li_{6.25}Si_{0.5}Sb_{0.25}Mo_{0.25}S₅Br | 0.5 Li_{6.25}Si_{0.5}Sb_{0.25}Mo_{0.25}S₅Br + H₂O → 0.0625 | −0.08 |
| | | Li₂SO₄ + 0.125 Li₃SbS₃ + 0.125 MoS₂ + 0.5 | |
| | | LiBr + H₂S + 0.25 Li₂SiO₃ + 0.8125 Li₂S | |
| | Li₆Si_{0.25}Sb_{0.5}Mo_{0.25}S₅Br | 0.5714 Li₆Si_{0.25}Sb_{0.5}Mo_{0.25}S₅Br + H₂O → 0.1071 | 0.02 |
| | | Li₂SO₄ + 0.2857 Li₃SbS₃ + 0.1429 MoS₂ + 0.5714 | |
| | | LiBr + H₂S + 0.1429 Li₄SiO₄ + 0.6071 Li₂S | |
| | Li_{5.75}Si_{0.25}Sb_{0.25}Mo_{0.5}S₅Br | 0.5714 Li_{5.75}Si_{0.25}Sb_{0.25}Mo_{0.5}S₅Br + H₂O → | 0.00 |
| | | 0.1071 Li₂SO₄ + 0.1429 Li₃SbS₃ + 0.2857 MoS₂ + | |
| | | 0.5714 LiBr + H₂S + 0.1429 Li₄SiO₄ + 0.75 Li₂S | |
| Sb—Mo—Br | Li_{5.75}Sb_{0.75}Mo_{0.25}S₅Br | H₂O + 0.0769 Li₂₃Sb₃MoS₂₀Br₄ → 0.308 LiBr + | 0.41 |
| | | H₂S + 0.365 Li₂S + 0.077 MoS₂ + 0.019 Li₂SO₄ + | |
| | | 0.231 Li₃SbO₄ | |
| | Li_{5.5}Sb_{0.5}Mo_{0.5}S₅Br | H₂O + 0.4 Li_{5.5}Sb_{0.5}Mo_{0.5}S₅Br → 0.4 LiBr + H₂S + | 0.28 |
| | | 0.55 Li₂S + 0.2 MoS₂ + 0.05 Li₂SO₄ + 0.2 Li₃SbO₄ | |
| | Li_{5.25}Sb_{0.25}Mo_{0.75}S₅Br | H₂O + 0.143 Li₂₁SbMo₃S₂₀Br₄ → 0.571 LiBr + | 0.15 |
| | | H₂S + 0.893 Li₂S + 0.429 MoS₂ + 0.107 Li₂SO₄ + | |
| | | 0.143 Li₃SbO₄ | |
| Si—Mo—Br | Li_{6.5}Si_{0.75}Mo_{0.25}S₅Br | H₂O + 0.1 Li₂₆Si₃MoS₂₀Br₄ → 0.4 LiBr + H₂S + | −0.15 |
| | | 0.78 Li₂S + 0.3 Li₂SiO₃ + 0.1 MoS₂ + 0.03 Li₂SO₄ | |
| | Li₆Si_{0.5}Mo_{0.5}S₅Br | H₂O + 0.4 Li₆Si_{0.5}Mo_{0.5}S₅Br → 0.4 LiBr + H₂S + | −0.05 |
| | | 0.55 Li₂S + 0.2 Li₄SiO₄ + 0.2 MoS₂ + 0.05 Li₂SO₄ | |
| | Li_{5.5}Si_{0.25}Mo_{0.75}S₅Br | H₂O + 0.143 Li₂₂SiMo₃S₂₀Br₄ → 0.571 LiBr + | −0.014 |
| | | H₂S + 0.893 Li₂S + 0.143 Li₄SiO₄ + 0.429 MoS₂ + | |
| | | 0.107 Li₂SO₄ | |
| Si—Sb—Mo—Cl | Li_{6.25}Si_{0.5}Sb_{0.25}Mo_{0.25}S₅Cl | H₂O + 0.1₂₅ Li₂₅Si₂SbMoS₂₀Cl₄ → 0.125 | −0.08 |
| | | Li₃SbS₃ + H₂S + 0.813 Li₂S + 0.5 LiCl + 0.25 | |
| | | Li₂SiO₃ + 0.125 MoS₂ + 0.063 Li₂SO₄ | |
| | Li₆Si_{0.25}Sb_{0.5}Mo_{0.25}S₅Cl | H₂O + 0.143 Li₂₄SiSb₂MoS₂₀Cl₄ → 0.286Li₃SbS₃ + | 0.02 |
| | | H₂S + 0.607 Li₂S + 0.571 LiCl + 0.143 Li₄SiO₄ + | |
| | | 0.143 MoS₂ + 0.107 Li₂SO₄ | |
| | Li_{5.75}Si_{0.25}Sb_{0.25}Mo_{0.5}S₅Cl | H₂O + 0.143 Li₂₃SiSbMo₂S₂₀Cl₄ → 0.143 | 0.004 |
| | | Li₃SbS₃ + H₂S + 0.75 Li₂S + 0.571 LiCl + 0.143 | |
| | | Li₄SiO₄ + 0.286MoS₂ + 0.107 Li₂SO₄ | |
| Sb—Mo—Cl | Li_{5.75}Sb_{0.75}Mo_{0.25}S₅Cl | 0.077 Li₂₃Sb₃MoS₂₀Cl₄ + H₂O → H₂S + 0.37 | 0.41 |
| | | Li₂S + 0.308 LiCl + 0.077 MoS₂ + 0.019 Li₂SO₄ + | |
| | | 0.23 Li₃SbO₄ | |
| | Li_{5.5}Sb_{0.5}Mo_{0.5}S₅Cl | 0.4 Li₅.₅Sb_{0.5}Mo_{0.5}S₅Cl + H₂O → H₂S + 0.55 | 0.28 |
| | | Li₂S + 0.4 LiCl + 0.2 MoS₂ + 0.05 Li₂SO₄ + 0.2 | |
| | | Li₃SbO₄ | |
| | Li_{5.25}Sb_{0.25}Mo_{0.75}S₅Cl | 0.14 Li₂₁SbMo₃S₂₀Cl₄ + H₂O → H₂S + 0.89 Li₂S + | 0.15 |
| | | 0.57 LiCl + 0.43 MoS₂ + 0.107 Li₂SO₄ + 0.14 | |
| | | Li₃SbO₄ | |
| Si—Mo—Cl | Li_{6.5}Si_{0.75}Mo_{0.25}S₅Cl | H₂O + 0.1 Li₂₆Si₃MoS₂₀Cl₄ → H₂S + 0.78 Li₂S + | −0.15 |
| | | 0.4 LiCl + 0.3 Li₂SiO₃ + 0.1 MoS₂ + 0.03 Li₂SO₄ | |
| | Li₆Si_{0.5}Mo_{0.5}S₅Cl | H₂O + 0.4 Li₆Si_{0.5}Mo_{0.5}S₅Cl → H₂S + 0.55 Li₂S + | −0.05 |
| | | 0.4 LiCl + 0.2 Li₄SiO₄ + 0.2 MoS₂ + 0.05 Li₂SO₄ | |
| | Li_{5.5}Si_{0.25}Mo_{0.75}S₅Cl | H₂O + 0.143 Li₂₂SiMo₃S₂₀Cl₄ → H₂S + 0.89 | −0.014 |
| | | Li₂S + 0.57 LiCl + 0.143 Li₄SiO₄ + 0.43 MoS₂ + | |
| | | 0.11 Li₂SO₄ | |
| Se | Li_{6.5}Si_{0.75}W_{0.25}Se_{0.5}S_{4.5}I | 0.44 Li₆.₅Si_{0.75}W_{0.25}Se_{0.5}S₄.₅I₁ + H₂O → 0.11 | −0.18 |
| | | Li₂Se + 0.11 Se + 0.44 LiI + H₂S + 0.33 Li₂SiO₃ + | |
| | | 0.78 Li₂S + 0.11 WS₂ | |
| | Li_{6.5}Si_{0.75}W_{0.25}SeS₄I | 0.44 Li₆.₅Si_{0.75}W_{0.25}Se₁S₄I₁ + H₂O → 0.33 Li₂Se + | −0.2 |
| | | 0.11 Se + 0.44 LiI + H₂S + 0.33 Li₂SiO₃ + 0.56 | |
| | | Li₂S + 0.11 WS₂ | |
| | Li_{6.5}Si_{0.75}W_{0.25}Se1.₂₅S_{3.75}I | 0.44 Li₆.₅Si_{0.75}W_{0.25}Se_{1.25}S_{3.75}I₁ + H₂O → 0.44 | −0.21 |
| | | Li₂Se + 0.11 Se + 0.44 LiI + H₂S + 0.33 Li₂SiO₃ + | |
| | | 0.44 Li₂S + 0.11 WS₂ | |
| | Li_{6.5}Si_{0.75}W_{0.25}Se_{1.75}S_{3.25}I | 4 Li₆.₅Si_{0.75}W_{0.25}Se_{1.75}S₃.₂₅I₁ + 6 H₂O → 6 Li₂Se + | −0.28 |
| | | 3 SiO₂ + Se + 4 LiI + WS₂ + H₂S + 10 LiHS | |
| | Li_{6.5}Si_{0.75}W_{0.25}Se₂S₃I | Li₆.₅Si_{0.75}W_{0.25}Se₂S₃I₁ + 3 H₂O → 3.5 Li₂Se + 1.5 | −0.29 |
| | | SiO₂ + 0.5 Se + 2 LiI + 0.5 WS₂ + H₂S + 4 LiHS | |
| | Li_{6.5}Si_{0.75}W_{0.25}Se_{2.25}S_{2.75}I | 1.33 Li₆.₅Si_{0.75}W_{0.25}Se₂.₂₅S_{2.75}I₁ + 2 H₂O → | −0.31 |
| | | 2.667 Li₂Se + SiO₂ + 0.33 Se + 1.33 LiI + 0.33 | |
| | | WS₂ + H₂S + 2 LiHS | |
| | Li_{6.5}Si_{0.75}W_{0.25}Se_{2.5}S_{2.5}I | Li₆.₅Si_{0.75}W_{0.25}Se₂.₅S₂.₅I₁ + 1.5 H₂O → 2.25 | −0.32 |
| | | Li₂Se + 0.75 SiO₂ + 0.25 Se + LiI + 0.25 WS₂ + | |
| | | H₂S + LiHS | |
| | Li_{6.5}Si_{0.75}W_{0.25}Se_{2.75}S_{2.25}I | 0.8 Li₆.₅Si_{0.75}W_{0.25}Se_{2.75}S₂.₂₅I₁ + 1.2 H₂O → 2 | −0.34 |
| | | Li₂Se + 0.6 SiO₂ + 0.2 Se + 0.8 LiI + 0.2 WS₂ + | |
| | | H₂S + 0.4 LiHS | |
| | Li_{6.5}Si_{0.75}W_{0.25}Se₃S₂I | 0.6667 Li₆.₅Si_{0.75}W_{0.25}Se₃S₂I₁ + H₂O → 1.8 | −0.37 |
| | | Li₂Se + 0.5 SiO₂ + 0.17 Se + 0.67 LiI + H₂S + | |
| | | 0.167 WS₂ | |
| | Li_{6.5}Si_{0.75}W_{0.25}Se_{3.25}S_{1.75}I | 0.67 Li₆.₅Si_{0.75}W_{0.25}Se₃.₂₅S_{1.75}I₁ + H₂O → 1.83 | −0.41 |
| | | Li₂Se + 0.5 SiO₂ + 0.17 Se + 0.08 WSe₂ + 0.67 | |
| | | LiI + H₂S + 0.08 WS₂ | |
| | Li_{6.5}Si_{0.75}W_{0.25}Se_{3.5}S_{1.5}I | 0.67 Li₆.₅Si_{0.75}W_{0.25}Se₃.₅S_{1.5}I₁ + H₂O → 1.83 | −0.47 |
| | | Li₂Se + 0.5 SiO₂ + 0.167 Se + 0.17 WSe₂ + 0.67 | |
| | | LiI + H₂S | |
| | Li_{6.5}Si_{0.75}W_{0.25}Se_{3.75}S1.₂₅I | 1.33 Li₆.₅Si_{0.75}W_{0.25}Se_{3.75}S_{1.25}I₁ + 2 H₂O → 3.67 | −0.52 |
| | | Li₂Se + 0.67 H₃S + SiO₂ + 0.67 Se + 0.33 WSe₂ + | |
| | | 1.33 LiI + H₂S | |
| | Li_{6.5}Si_{0.75}W_{0.25}Se₄SI | Li₆.₅Si_{0.75}W_{0.25}Se₄S₁I₁ + H₂O → 2.75 Li₂Se + | −0.46 |
| | | H₂S + 0.5 SiO₂ + 0.25 Se + 0.25 WSe₂ + LiI + | |
| | | 0.25 SiSe₂ | |
| | Li_{6.5}Si_{0.75}W_{0.25}Se_{4.25}S_{0.75}I | 1.33Li₆.₅Si_{0.75}W_{0.25}Se₄.₂₅S_{0.75}I₁ + H₂O → 3.67 | −0.45 |
| | | Li₂Se + H₂S + 0.5 SiO₂ + 0.33 Se + 0.33 WSe₂ + | |
| | | 1.33 LiI + 0.5 SiSe₂ | |
| | Li_{6.5}Si_{0.75}W_{0.25}Se_{4.5}S_{0.5}I | 2 Li₆.₅Si_{0.75}W_{0.25}Se₄.₅S_{0.5}I₁ + H₂O → 5.5 Li₂Se + | −0.43 |
| | | H₂S + 0.5 SiO₂ + 0.5 Se + 0.5 WSe₂ + 2 LiI + SiSe₂ | |
| | Li_{6.5}Si_{0.75}W_{0.25}Se_{4.75}S_{0.25}I | 4 Li₆.₅Si_{0.75}W_{0.25}Se₄.₇₅S_{0.25}I₁ + H₂O → 11 Li₂Se + | −0.43 |
| | | H₂S + 0.5 SiO₂ + Se + WSe₂ + 4 LiI + 2.5 SiSe₂ | |

As the gas generation energy decreases, generation of hydrogen sulfide gas is easier in hydrolysis of the sulfide-based solid electrolyte. That is, as the gas generation energy increases, generation of hydrogen sulfide gas may be suppressed and moisture stability may be increased.

Referring to Table 2, the gas generation energies of the sulfide-based solid electrolytes doped with an element having an oxidation number of 4 or a transition metal having an oxidation number of 6 were calculated to be higher. It is predicted that tungsten (W) and molybdenum (Mo) reacted with sulfur (S) to form WS₂ and MoS₂, and thereby, generation of H₂S gas was suppressed.

### Test Example 4: Interfacial Energies Between Sulfide-Based Solid Electrolytes Having Various Compositions and Respective Elements of Cathode

Interfacial reaction energies between a cathode active material and a coating composition thereof generally included in a cathode and sulfide-based solid electrolytes having various compositions were calculated through computer simulation. A detailed calculation method is as follows.

xC^{a}+(1−x)C^{b}→C_{equil} Equation eq1:

(C^{a} and C^{b}=compositions of two phases in contact, C_{equil}=low phase equilibrium energy, and 0<x<1)

ΔE[C^{a},C^{b}]=min{E_{pd}[xC^{a}+(1−x)C^{b}]−xE[C^{a}]−(1−x)E[C^{b}]} Equation eq2:

(E_{pd}: a combination of reaction products having the lowest energy in xC^{a}+(1−x)C^{b})

Related energy calculated using DFT may be acquired from the database of the materials project, and a function to find the minimum value is in the materials project.

Equation eq3 was derived using Equation eq2 in order to describe a phenomenon in a battery cell.

ϕ_{pd}[C,μ_{Li}]=min{E_{pd}[c+μ_{Li}]−n_{Li}[c]μ_{Li}} Equation eq3:

ϕ_{pd}[c, μ_{Li}] indicates the composition c having the lowest energy in μ_{Li}, in the same manner as E_{pd}. Here, lithium potential determined from a calculated average cathode voltage is used.

In Equation eq4, electric potential on the interface is changed by causing the electrolyte to be in equilibrium with the external lithium potential and to react with the cathode, and interfacial stability is determined by a μ_{Li} function. The magnitude of Δϕ determines thermodynamic stability.

Δϕ_{pd}[c_{cathode},c_{electrode},μ_{Li}]=min{ϕ_{pd}[X^{c}^{_{cathode}}+(1−X)^{c}^{_{cathode}},μ_{Li}]−X^{ϕ}([c_{cathode},μ_{Li}]−(1−X)^{ϕc}^{_{cathode}},μ_{Li}} Equation eq4:

Finally, interfacial reaction energy between the electrolyte and the cathode may be confirmed using Δϕ.

The interfacial reaction energies of the sulfide-based solid electrolytes having various compositions were calculated through the above process, and are set forth in Table 3 below.

TABLE 3

| | Cathode active material and coating material (meV/atom) | | | | | | |
|---|---|---|---|---|---|---|---|
| Chemical formula | NCM811 | Li₂ZrO₃ | NiNbO₃ | Si | C₆ | LiF | LiI |
| Li₆PS₅Cl | −0.424 | −0.091 | −0.108 | −0.087 | 0.000002 | 0.000002 | 0.000002 |
| Li_{6.25}Si_{0.5}Sb_{0.25}W_{0.25}S₅I | −0.38 | −0.065 | −0.064 | −0.059 | 0.000 | 0.000 | 0.000 |
| Li₆Si_{0.25}Sb_{0.5}W_{0.25}S₅I | −0.37 | −0.042 | −0.036 | −0.090 | 0.000 | 0.000 | 0.000 |
| Li_{5.75}Si_{0.25}Sb_{0.25}W_{0.5}S₅I | −0.37 | 0.043 | −0.036 | −0.086 | 0.000 | 0.000 | 0.000 |
| Li_{5.75}Sb_{0.75}W_{0.25}S₅I | −0.36 | −0.013 | −0.010 | −0.119 | 0.000 | 0.000 | 0.000 |
| Li_{5.5}Sb_{0.5}W_{0.5}S₅I | −0.36 | −0.015 | −0.011 | −0.115 | 0.000 | 0.000 | 0.000 |
| Li_{5.25}Sb_{0.25}W_{0.75}S₅I | −0.36 | −0.015 | −0.012 | −0.112 | 0.000 | 0.000 | 0.000 |
| Li_{6.5}Si_{0.75}W_{0.25}S₅I | −0.39 | −0.082 | −0.086 | −0.033 | −0.003 | 0.000 | 0.000 |
| Li₆Si_{0.5}W_{0.5}S₅I | −0.38 | −0.068 | −0.066 | −0.064 | −0.007 | 0.000 | 0.000 |
| Li_{5.5}Si_{0.25}W_{0.75}S₅I | −0.37 | −0.051 | −0.042 | −0.093 | −0.011 | 0.000 | 0.000 |
| Li_{6.25}Si_{0.5}Sb_{0.25}Mo_{0.25}S₅I | −0.37 | −0.065 | −0.064 | −0.065 | 0.000 | 0.000 | 0.000 |
| Li₆Si_{0.25}Sb_{0.5}Mo_{0.25}S₅I | −0.36 | −0.042 | −0.036 | −0.095 | 0.000 | 0.000 | 0.000 |
| Li_{5.75}Si_{0.25}Sb_{0.25}Mo_{0.5}S₅I | −0.36 | −0.043 | −0.036 | −0.097 | 0.000 | 0.000 | 0.000 |
| Li_{5.75}Sb_{0.75}Mo_{0.25}S₅I | −0.36 | −0.013 | −0.01 | −0.125 | 0.000 | 0.000 | 0.000 |
| Li_{5.5}Sb_{0.5}Mo_{0.5}S₅I | −0.35 | −0.015 | −0.011 | −0.126 | 0.000 | 0.000 | 0.000 |
| Li_{5.25}Sb_{0.25}Mo_{0.75}S₅I | −0.35 | −0.015 | −0.012 | −0.127 | 0.000 | 0.000 | 0.000 |
| Li_{6.5}Si_{0.75}Mo_{0.25}S₅I | −0.38 | −0.082 | −0.086 | −0.038 | −0.003 | 0.000 | 0.000 |
| Li₆Si_{0.5}Mo_{0.5}S₅I | −0.37 | −0.068 | −0.066 | −0.074 | −0.007 | 0.000 | 0.000 |
| Li_{5.5}Si_{0.25}Mo_{0.75}S₅I | −0.36 | −0.051 | −0.042 | −0.109 | −0.011 | 0.000 | 0.000 |
| Li_{6.5}Ge_{0.75}W_{0.25}S₅I | −0.355 | −0.008 | −0.01 | −0.056 | −0.003 | 0.000 | 0.000 |
| Li₆Ge_{0.5}W_{0.5}S₅I | −0.358 | −0.016 | −0.013 | −0.078 | −0.007 | 0.000 | 0.000 |
| Li_{5.5}Ge_{0.25}W_{0.75}S₅I | −0.36 | −0.022 | −0.016 | −0.1 | −0.011 | 0.000 | 0.000 |
| Li_{6.25}Ge_{0.5}Sb_{0.25}W_{0.25}S₅I | −0.356 | −0.008 | −0.009 | −0.074 | 0.000 | 0.000 | 0.000 |
| Li₆Ge_{0.25}Sb_{0.5}W_{0.25}S₅I | −0.357 | −0.011 | −0.01 | −0.096 | 0.000 | 0.000 | 0.000 |
| Li_{5.75}Ge_{0.25}Sb_{0.25}W_{0.5}S₅I | −0.358 | −0.012 | −0.011 | −0.093 | 0.000 | 0.000 | 0.000 |
| Li_{6.5}Ge_{0.75}Mo_{0.25}S₅I | −0.352 | −0.008 | −0.01 | −0.061 | −0.003 | 0.000 | 0.000 |
| Li₆Ge_{0.5}Mo_{0.5}S₅I | −0.352 | −0.016 | −0.013 | −0.088 | −0.007 | 0.000 | 0.000 |
| Li_{5.5}Ge_{0.25}Mo_{0.75}S₅I | −0.352 | −0.022 | −0.016 | −0.0115 | −0.011 | 0.000 | 0.000 |
| Li_{6.25}Ge_{0.5}Sb_{0.25}Mo_{0.25}S₅I | −0.353 | −0.008 | −0.009 | −0.079 | 0.000 | 0.000 | 0.000 |
| Li₆Ge_{0.25}Sb_{0.5}Mo_{0.25}S₅I | −0.354 | −0.011 | −0.01 | −0.102 | 0.000 | 0.000 | 0.000 |
| Li_{5.75}Ge_{0.25}Sb_{0.25}Mo_{0.5}S₅I | −0.352 | −0.012 | −0.011 | −0.103 | 0.000 | 0.000 | 0.000 |
| Li_{6.5}Si_{0.75}W_{0.25}Se_{0.25}S_{4.75}I | −0.384 | −0.08 | −0.089 | −0.024 | 0.000 | 0.000 | 0.000 |
| Li_{6.5}Si_{0.75}W_{0.25}Se_{0.25}S_{4.75}I | −0.384 | −0.08 | −0.089 | −0.024 | 0.000 | 0.000 | 0.000 |
| Li_{6.5}Si_{0.75}W_{0.25}Se_{0.5}S_{4.5}I | −0.384 | −0.08 | −0.092 | −0.024 | 0.000 | 0.000 | 0.000 |
| Li_{6.5}Si_{0.75}W_{0.25}Se_{0.75}S_{4.25}I | −0.384 | −0.08 | −0.096 | −0.024 | 0.000 | 0.000 | 0.000 |
| Li_{6.5}Si_{0.75}W_{0.25}SeS₄I | −0.383 | −0.08 | −0.098 | −0.024 | 0.000 | 0.000 | 0.000 |
| Li_{6.5}Si_{0.75}W_{0.25}Se_{1.25}S_{3.75}I | −0.383 | −0.08 | −0.098 | −0.024 | 0.000 | 0.000 | 0.000 |
| Li_{6.5}Si_{0.75}W_{0.25}Se_{1.5}S_{3.5}I | −0.383 | −0.08 | −0.098 | −0.024 | 0.000 | 0.000 | 0.000 |
| Li_{6.5}Si_{0.75}W_{0.25}Se_{1.75}S_{3.25}I | −0.382 | −0.08 | −0.098 | −0.024 | 0.000 | 0.000 | 0.000 |
| Li_{6.5}Si_{0.75}W_{0.25}Se₂S₃I | −0.382 | −0.08 | −0.098 | −0.024 | 0.000 | 0.000 | 0.000 |
| Li_{6.5}Si_{0.75}W_{0.25}Se_{2.25}S_{2.75}I | −0.381 | −0.08 | −0.098 | −0.024 | 0.000 | 0.000 | 0.000 |
| Li_{6.5}Si_{0.75}W_{0.25}Se_{2.5}S_{2.5}I | −0.381 | −0.08 | −0.098 | −0.024 | 0.000 | 0.000 | 0.000 |
| Li_{6.5}Si_{0.75}W_{0.25}Se_{2.75}S_{2.25}I | −0.381 | −0.08 | −0.098 | −0.024 | 0.000 | 0.000 | 0.000 |
| Li_{6.5}Si_{0.75}W_{0.25}Se₃S₂I | −0.38 | −0.08 | −0.098 | −0.022 | 0.000 | 0.000 | 0.000 |
| Li_{6.5}Si_{0.75}W_{0.25}Se_{3.25}S_{1.75}I | −0.38 | −0.081 | −0.099 | −0.022 | 0.000 | 0.000 | 0.000 |
| Li_{6.5}Si_{0.75}W_{0.25}Se_{3.5}S_{1.5}I | −0.38 | −0.082 | −0.1 | −0.022 | 0.000 | 0.000 | 0.000 |
| Li_{6.5}Si_{0.75}W_{0.25}Se_{3.75}S_{1.25}I | −0.38 | −0.083 | −0.1 | −0.022 | 0.000 | 0.000 | 0.000 |
| Li_{6.5}Si_{0.75}W_{0.25}Se₄SI | −0.378 | −0.084 | −0.099 | −0.022 | 0.000 | 0.000 | 0.000 |
| Li_{6.5}Si_{0.75}W_{0.25}Se_{4.25}S_{0.75}I | −0.376 | −0.085 | −0.099 | −0.022 | 0.000 | 0.000 | 0.000 |
| Li_{6.5}Si_{0.75}W_{0.25}Se_{4.5}S_{0.5}I | −0.371 | −0.086 | −0.097 | −0.022 | 0.000 | 0.000 | 0.000 |
| Li_{6.5}Si_{0.75}W_{0.25}Se_{4.75}S_{0.25}I | −0.365 | −0.086 | −0.096 | −0.023 | 0.000 | 0.000 | 0.000 |
| Li_{6.5}Si_{0.75}W_{0.25}Se₅I | −0.355 | −0.086 | −0.096 | −0.024 | 0.000 | 0.000 | 0.000 |

Referring to Table 3, it may be confirmed that the interfacial reaction energies of the sulfide-based solid electrolytes according to the present disclosure are higher than the conventional argyrodite-type sulfide-based solid electrolyte (Li₆PS₅Cl). Thereby, it is predicted that, it is difficult to cause decomposition reaction in the sulfide-based solid electrolytes according to the present disclosure, and thus, stability on the interfaces of the sulfide-based solid electrolytes according to the present disclosure may be increased.

As is apparent from the above description, the present disclosure provides a sulfide-based solid electrolyte having an argyrodite-type crystal structure which includes an element having an oxidation number of 4 and a transition metal having an oxidation number of 6 so as to improve both ionic conductivity and moisture stability of the sulfide-based solid electrolyte in a balanced way.

The disclosure has been described in detail with reference to preferred embodiments thereof. However, it will be appreciated by those skilled in the art that changes may be made in these embodiments without departing from the principles and spirit of the disclosure, the scope of which is defined in the appended claims and their equivalents.

1. A sulfide-based solid electrolyte expressed as
Li_{5+2x+y}AₓSb_{y}B_{1-x-y}S_{5-z}Se_{z}X;
wherein, A is an element having an oxidation number of 4, B is a transition metal having an o tion number of 6, X is at least one selected from Cl, Br, I, and combinations thereof, 0<x<1, 0<y<1,0<x+y<1, and 0<x<5.

2. The sulfide-based solid electrolyte of claim 1, wherein the element having the oxidation number of 4 comprises one selected from the group consisting of silicon (Si), germanium (Ge), tin (Sn), and combinations thereof.

3. The sulfide-based solid electrolyte of claim 1, wherein the transition metal having the oxidation number of 6 comprises one selected from the group consisting of tungsten (W), molybdenum (Mo), and a combination thereof.

4. The sulfide-based solid electrolyte of claim 1, configured to have an argyrodite-type crystal structure.

5. The sulfide-based solid electrolyte of claim 4, wherein the element having the oxidation number of 4 and the transition metal having the oxidation number of 6 are located at 4b sites of the argyrodite-type crystal structure.

6. The sulfide-based solid electrolyte of claim 1, wherein 1-x-y configured to indicate an amount of the transition metal having the oxidation number of 6 is greater than 0 but less than 0.5.

7. The sulfide-based solid electrolyte of claim 1, wherein z is greater than 0 but less than 3.5.

8. The sulfide-based solid electrolyte of claim 1, configured to belong to a space group F-43m.

9. The sulfide-based solid electrolyte of claim 1, wherein selenium (Se) is substituted for at least some of sulfur (S).
